(19) United States
(12) Patent Application Publication
(10) Pub. No.: US 2007/0153846 A1
(43) Pub. Date: Jul. 5, 2007

(54) Temperature control of optic device

(75) Inventor: Michael Clements, Newton Abbot (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY PLC

(21) Appl. No.: 11/311,323

(22) Filed: Dec. 20, 2005

(51) Int. Cl. H01S 3/04

(52) U.S. Cl. 372/34

(57) ABSTRACT

A system including: an optic device; a thermoelectric controller on which the optic device is mounted; and a class-D audio amplifier for driving the thermoelectric controller.

### FIELD OF THE INVENTION

This invention relates to controlling the temperature of an optic device, and in particular to a technique for driving a thermoelectric controller (TEC) on which an optic device is mounted.

### BACKGROUND OF THE INVENTION

Thermoelectric coolers are often used to regulate the temperature of optic devices. A thermoelectric cooler (TEC), such as a Peltier device, is a solid state heat-pump, whereby, when a current is passed through the TEC, heat is transferred from one side of the TEC to the other, producing a cold side and a hot side. A component such as an optic device mounted on the cold side can therefore have heat transferred away from it to the hot side, from where it can be dissipated. In addition to being used as coolers, TECs can also be used to heat a component by reversing the direction of the current through the TEC. A TEC is therefore useful in applications where a temperature must be maintained, as is generally the case with optic devices, particularly those used for communication purposes.

Known low-power and high-efficiency TEC drive circuits for optic devices for communication purposes use dedicated driver integrated circuits (ICs). These ICs are typically designed for high current operation and provide many features specifically targeted for TEC modules. For example, a typical TEC driver will include a thermistor input and an error amplifier with a switching output stage. This generally leads to large ICs that require many external support components and hence a high cost. In particular, for applications in which only a low TEC current is required, this also leads to a lower efficiency.

### SUMMARY OF THE INVENTION

It is an aim of the present invention to provide an alternative technique for driving a TEC.

According to a first aspect of the present invention, there is provided a system including: an optic device; a thermoelectric controller on which the optic device is mounted; and a class-D audio amplifier for driving the thermoelectric controller.

In one embodiment, the class-D audio amplifier is arranged for driving the thermoelectric controller to both heat and cool the optic device.

In one embodiment, the class-D audio amplifier includes first and second outputs and first and second inputs, and wherein a polarity and a magnitude of voltages at the first and second outputs are dependent on voltages applied to the first and second inputs.

In one embodiment, the system further comprises a low-pass filter connected between an output of the class-D audio amplifier and the thermoelectric controller.

In one embodiment, the system further comprises a digital to analogue converter connected to an input of the class-D audio amplifier.

In one embodiment, the optic device is an optoelectronic device.

In one embodiment, the optic device is either (i) a laser source, having a fixed or tuneable wavelength, and being continuous-wave (CW) or modulated, either directly or through means of a modulator (such as a Mach-Zender (MZ) modulator or an electroabsoprtion modulator (EA)), or (ii) an optical receiver.

In one embodiment, the system further includes a microprocessor for generating on the basis of an indicator of an actual temperature of the optic device a signal for determining a d.c. input to the class-D audio amplifier, and a digital analogue convertor to which said signal generated by the microprocessor is provided.

According to another aspect of the present invention, there is provided a small form factor (SFF) module including: a thermoelectric controller and a class-D audio amplifier for driving the thermoelectric controller.

According to another aspect of the present invention, there is provided an electronic circuit for controlling the temperature of an optic device using a thermoelectric controller, the electronic circuit including: a class-D audio amplifier for driving the thermoelectric controller.

According to another aspect of the present invention, there is provided a use of a class-D audio amplifier for driving a thermoelectric cooler on which an optic device is mounted.

According to another aspect of the present invention, there is provided a method of driving a thermoelectric cooler on which an optic device is mounted using a class-D audio amplifier, including the step of providing a dc control signal to an input of the class-D audio amplifier on the basis of an indicator of an actual temperature of the optic device.

According to another aspect of the present invention, there is provided a Tuneable Transmitter Assembly (TTA) module including: a thermoelectric controller and a class-D audio amplifier for driving the thermoelectric controller.

In one embodiment, the Tuneable Transmitter Assembly module is an integratable Tuneable Transmitter Assembly module.

### BRIEF DESCRIPTION OF THE DRAWINGS

For a better understanding of the present invention and to show how the same may be put into effect, reference will now be made, by way of example, to the following drawings in which:

FIG. 1 shows an optic module according to an embodiment of the invention; and

FIG. 2 shows key elements of a single inpuvoutput class-D audio amplifier.

### DESCRIPTION OF PREFERRED EMBODIMENT

It has been found that high efficiency, low cost and small size TEC driver circuits for controlling the temperature of optic devices can be implemented using class-D audio amplifiers.

In a class-D audio amplifier (which is a kind of a “switching amplifier” or “pulse width modulation (PWM) amplifier”), the output devices (typically transistors) are switched either fully on or fully off. When an output transistor is fully off there is no current flow through it, and when it is fully on the voltage across the transistor is very low (ideally zero).

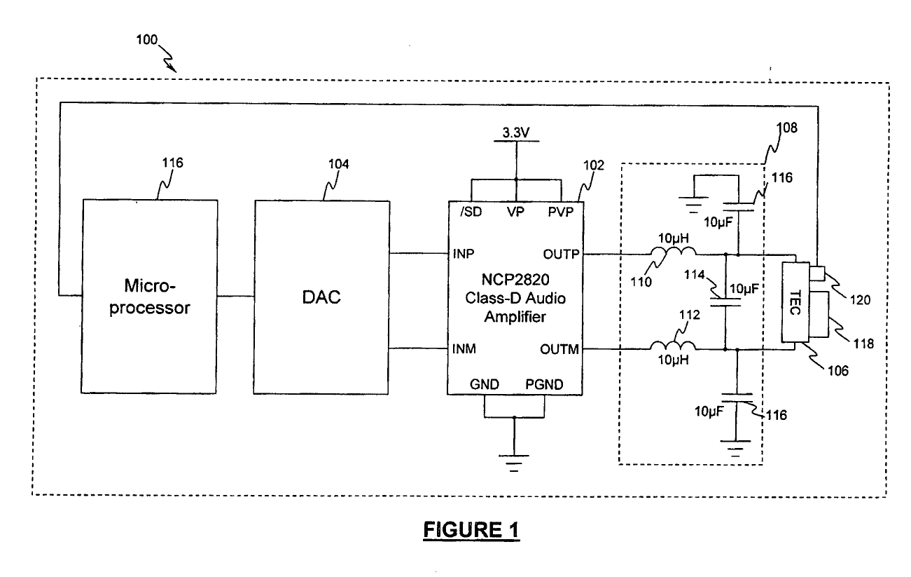

FIG. 1 shows an optic module 100 according to an embodiment of the invention. The module may for example be a small form factor (SFF) module or an (integratable) Tuneable Transmitter Assembly (TTA/iTTA).module. In the embodiment shown in FIG. 1, a class-D audio amplifier 102 (NCP2820 differential amplifier) is used. The use of a differential amplifier allows the TEC 106 to be driven in both directions i.e. in both heating and cooling modes. The class-D amplifier, is connected to a power supply (not shown) with pins VP and PVP, and is connected to ground with pins GND and PGND. The NCP2820 class-D audio amplifier 102 also has a shutdown pin/SD, which is connected to the supply voltage to put the amplifier into an operational state or connected to the microprocessor 116 as required.

The differential class-D audio amplifier 102 has positive and negative inputs (labelled INP and INM, respectively). These inputs are supplied with analogue voltage levels provided by a digital to analogue converter (DAC) 104. The voltage levels provided by the DAC 104 determine the magnitude and direction of the voltage applied to the TEC 106. The DAC 104 may be connected to the amplifier 102 via voltage scaling components (active and/or passive) if required. Mounted on the TEC is an optic device 118, the temperature of which is being controlled. The DAC 104 is controlled by a microprocessor 116 that determines the voltage levels that are required. The microprocessor 116 can utilise information from a temperature sensor 120 mounted on the TEC 106, such as a thermistor, when determining the required voltages.

The output of the class-D audio amplifier 102 is made up of differential outputs (labelled OUTP and OUTM, respectively) that are a high power representation of the input voltages applied to INP and INM.

A low pass filter 108 is used to remove the PWM carrier signal from the outputs of the class-D audio amplifier 102 before application to the TEC 106. The low pass filter comprises an inductor 110 in series with the OUTP output, an inductor 112 in series with OUTM output, a capacitor 114 in parallel with the TEC 106 and capacitors 116 from the TEC 106 to ground. Typical values for the inductors 110 and 112 are 10 μH and a typical value for the capacitors 114, 116 is 10 pF.

This type of TEC driver circuit is considered to be particularly suitable for driving TECs with low current requirements. In addition, as class-D audio amplifiers are produced in very high volumes for consumer electronics applications, they are also low cost.

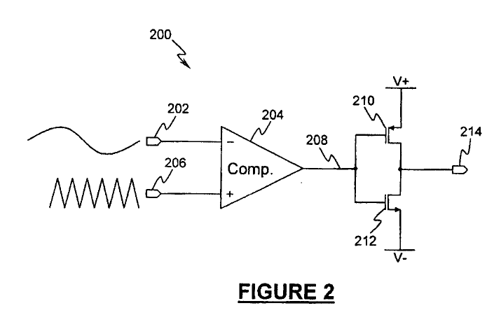

The operation of a class-D amplifier is described with reference to FIG. 2, which shows an example of a single input/output class-D audio amplifier. An input signal is applied to a first input 202 of a comparator 204, and a triangle waveform of significantly higher frequency is applied to a second input 206 of the comparator. The resulting output 208 of the comparator 204 is a PWM representation of the input signal, in which the width of a pulse is representative of the magnitude of the input signal. This PWM signal is then applied to the output transistors 210, 212, which are switched fully on or fully off according to the PWM pulses. This produces a high-power amplified version of the PWM signal at the output of the transistors 214.

Class-D audio amplifiers are designed to amplify audio signals. Audio signals are typically sinusoidal and have a frequency range of around 20 Hz to 20 KHz. the inventors of the present invention have found that class-D audio amplifiers are also advantageous for use in driving TECs with DC voltages. This is particularly the case for class-D audio amplifiers that have differential drive, such that the direction of current flow through the TEC can be controlled to give either a heating or cooling effect.

The class-D audio amplifier used in the above-described embodiment has no internal AC-coupled stages. It is stable in driving the low resistance of the TEC (typically around 1), and it is capable of driving a DC current without overheating. It is produced by ON Semiconductor

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A system including: an optic device; a thermoelectric controller on which the optic device is mounted; and a class-D audio amplifier for driving the thermoelectric controller.

2. A system according to claim 1, wherein the class-D audio amplifier is arranged for driving the thermoelectric controller to both heat and cool the optic device.

3. A system according to claim 1, wherein the class-D audio amplifier includes first and second outputs and first and second inputs, and wherein a polarity and a magnitude of voltages at the first and second outputs are dependent on voltages applied to the first and second inputs.

4. A system according to claim 1, further comprising a low-pass filter connected between an output of the class-D audio amplifier and the thermoelectric controller.

5. A system according to claim 1, further comprising a digital to analogue converter connected to an input of the class-D audio amplifier.

6. A system according to claim 1, wherein the optic device is an optoelectronic device.

7. A system according to claim 1, wherein the optic device is either (i) a laser source, having a fixed or tuneable wavelength, and being continuous-wave (CW) or modulated, either directly or through means of a modulator (such as a Mach-Zender (MZ) modulator or an electroabsoprtion modulator (EA)), or (ii) an optical receiver.

8. A system according to claim 1, further including a microprocessor for generating on the basis of an indicator of an actual temperature of the optic device a signal for determining a d.c. input to the class-D audio amplifier.

9. A system according to claim 8, further including a digital analogue convertor to which said signal generated by the microprocessor is provided.

10. A small form factor (SFF) module including: a thermoelectric controller and a class-D audio amplifier for driving the thermoelectric controller.

11. An electronic circuit for controlling the temperature of an optic device using a thermoelectric controller, the electronic circuit including: a class-D audio amplifier for driving the thermoelectric controller.

12. A use of a class-D audio amplifier for driving a thermoelectric cooler on which an optic device is mounted.

13. A method of driving a thermoelectric cooler on which an optic device is mounted using a class-D audio amplifier, including the step of providing a dc control signal to an input of the class-D audio amplifier on the basis of an indicator of an actual temperature of the optic device.

14. A Tuneable Transmitter Assembly (TTA) module including: a thermoelectric controller and a class-D audio amplifier for driving the thermoelectric controller.

15. A Tuneable Transmitter Assembly module according to claim 14, which is an integratable Tuneable Transmitter Assembly module.
